(19) United States
(12) Patent Application Publication
(10) Pub. No.: US 2022/0062666 A1
(43) Pub. Date: Mar. 3, 2022

(54) Blower Assisted Positive Pressure Wearable Personal Air Filtration System And Methods of Use Thereof

(71) Applicant: Bariss LLC, Steamboat Springs, CO (US)

(72) Inventors: Mark Linn Harris, South Kingstown, RI (US); David Ernest Barnes, Steamboat Springs, CO (US)

(21) Appl. No.: 17/446,124

(22) Filed: Aug. 26, 2021

Related U.S. Application Data
(60) Provisional application No. 63/070,609, filed on Aug. 26, 2020.

(51) Int. Cl. A62B 7/10; F04D 25/06; A62B 23/02; A62B 7/02

(52) U.S. Cl. CPC A62B 7/10; A62B 7/02; A62B 23/025; F04D 25/0673

(57) ABSTRACT

The present invention is directed to a wearable personal air-filtration system having an inlet air supply module comprising a portable housing securing an inlet air filter and a motorized blower unit configured to draw ambient air through the inlet air filter and generate pressurized air. The inlet air supply module is in fluid communication with a face covering having one or more exhaust filters configured to filter expired and/or pressurized air from the face covering. The personal air-filtration system may be specifically configured for use during low to high-intensity exercise, such that the air flow of the system may be at least 2.5 times the Maximum Voluntary Ventilation (MVV) or Maximum Breathing Capacity (MBC) of an adult male during low to high intensity exercise.

### CROSS REFERENCES TO RELATED APPLICATION

This application claims the benefit of and priority to U.S. Provisional Application No. 63/070,609, filed Aug. 26, 2020. The entire specification and figures of the above-referenced application is hereby incorporated in its entirety by reference.

### TECHNICAL FIELD

The inventive technology relates to the field of air filtration, and more specifically to a motor-assisted, positive pressure face mask for filtering air for breathing. In one preferred aspect, the inventive technology relates to a blower-assisted personal air-filtration device configured to be worn by a user during low to high-intensity exercise.

### BACKGROUND

Various face masks have been used in an effort to filter air for a variety of applications. For example, medical masks have been used in hospital environments to protect the user against inhaling undesirable viruses or bacteria. Other masks have been used to filter dirt and other airborne particles. However, many of these face masks can be difficult to implement, deteriorate over time, and fail to provide adequate filtering, particularly when used in different applications. In addition, such traditional masks often do not form a tight seal around the user's face allowing viruses, bacteria, or other particulates to enter the internal mask environment where they may be inhaled. More importantly, such traditional masks allow viruses, bacteria, or other particulates that may be exhaled by a user to escape the mask and be released into the environment potentially endangering others. In addition to this lack of a proper seal, such traditional mask are not designed to be used during rigorous exercise limiting their ability to be adaptable to indoor gyms, or other recreational settings that require low to high intensity exercise.

In an effort to address some of these concerns, certain masks have been coupled with positive pressure generating motorized equipment. For example, powered air-purifying respirators (PAPRs) continually supply positive air pressure to a respirator to maintain positive pressure in the respirator. PAPRs are generally used in military, industrial, or hazardous environments to provide personal respiratory protection by preventing ambient air from entering the user's mask, helmet, or hood. Respiratory hazards might include particulate matter, harmful gases, or vapors, which are removed by passing the ambient air through the filter.

Typically, a powered air-purifying respirator includes a powered fan that forces ambient air through one or more filters for delivery to an inlet opening in the respirator. The fan and filter may be mounted on a facemask, or in some cases, may be mounted on a belt or backpack and connected to the facemask through a hose and a fan. Power for the fans are typically mounted remotely from the facemask but can also be mounted on the mask itself. However, such PAPRs are generally large and often require a covering that is incorporated into a larger facemask or full-body suit to be worn by the user. Moreover, traditional PAPRs are not designed for use during vigorous exercise, and more specifically, are not configured to supply sufficient air required for a user participating in low to high intensity exercise.

To address these issues, the current inventive technology describes a wearable breathing apparatus generally consisting of a face covering, such as a mask, connector or hose, and a powered inlet air supply module which supplies HEPA or ULPA filtered air which is driven by an electrically powered motorized blower unit. The wearable breathing apparatus of the invention also filters the exhaust air exiting the face covering using a HEPA, or other filter to ensure potential external contamination is minimized.

The wearable apparatus may be unitary or modular in nature, and is especially configured to be used during fitness exercise in indoor spaces such as gyms and fitness centers, but could also be applicable to use in other public or enclosed spaces where social distancing is not possible such as, but not limited to airplanes, buses, trains, cruise ships, classrooms and auditoriums. The airflow amount of the wearable device is adjustable by the wearer and is sized for maximum capacity to effectively supply the Maximum Voluntary Ventilation (MVV), also referred to as Maximum Breathing Capacity (MBC) of a fit adult male, or 170 L/min (6 CFM). The wearable air-filtration system effectively filters pollution, particulates, bacteria, and viruses from the air prior to inhalation and additionally filters the exhalation air similarly to ensure that the wearer minimizes his/her potential to contaminate others.

### SUMMARY OF THE INVENTION

One aspect of the present invention include novel systems, methods and apparatus for a personal air-filtration system having improved filtration (See FIG. 4) and breathability (See FIG. 5) characteristics comparted to traditional masks of air purifying devices.

One aspect of the present invention is to provide highly filtered air using HEPA or ULPA technology to the user through use of a near leak-tight mask system that allows only filtered inlet air to enter the mask for inhalation and which then allows exhalation air to pass through a separate filter prior to exhausting to the environment. An air pressure generation unit, such as a motorized blower may be specifically designed to provide enough inhalation air to the user to meet MVV or MBC requirements while also providing a positive pressure to the inside of the face covering to ensure comfort and to provide fresh air access that feels similar to breathing without a mask. The motorized blower design also decreases inlet airflow significantly during exhalation and increases mask positive pressure to ensure exhaust air exits only from the outlet filter and does not re-enter the inlet line, thus not requiring a one-way check valve in the inlet flow path which would add significant performance impact.

In another aspect the present invention includes a method and apparatus for providing filtered, pressurized air to a wearable face covering for use during, but not limited to low to high intensity exercise that also filters the user's exhalation air to effectively eliminate the potential of contamination of the surrounding environment. In one embodiment, up to 99.7% of the environmental contaminants may be filtered out prior to inhalation and up to 99.7% of potential user contaminants may be filtered out prior to exhausting back into the local environment.

In another aspect the present invention includes a method and apparatus for providing a modular, electrically powered, wearable, highly filtered, personal breathing apparatus that is airflow adjustable to be used in a low to high intensity exercise environment as well as a non-exercise environment for protection of the user against pollution, particulates, bacteria, and viruses and to protect others in the vicinity of the user against potential contamination from bacteria or viruses from the user.

In one preferred aspect of the invention, unfiltered, or ambient air is drawn into the HEPA or ULPA filter by the motorized blower unit of an inlet air supply module. The air passes through a HEPA or ULPA filter media to remove pollutants, particulates, bacteria, and viruses prior to entering the inlet air supply module. The pressure drop induced by the resistance of the filter media is overcome by the motorized blower unit which acts to produce pressurized airflow to the outlet of the blower. The filtered air flows from the HEPA or ULPA filter media to the motorized blower unit inlet where it then enters a rotating compressor assembly, in this case a rotating compressor rotor assembly. The compressor rotor assembly accelerates the filtered airflow pulling the flow through the filter media, and then diffuses the high velocity air to convert the high velocity into pressure. This dynamic pressure mechanism creates flow and pressure that may be approximately inversely proportional to each other, such that higher pressures are produced at lower flow rates and lower pressures are created at higher flow rates.

In another preferred aspect of the invention, filtered, pressurized air flows from the motorized blower unit outlet through a connector, such as a flexible connection hose to a wearable face covering, such as a mask. The wearable face covering may be configured to be a flexible face covering which seals to the user over the nose and mouth. The connector may be coupled with a mask inlet connection allowing air to flow from the motorized blower unit outlet through a connector to the mask. The filtered, pressurized inlet air flows into the mask inlet allowing air to flow from the motorized blower unit outlet through a connector to the mask. and is either used for user inspiration or exits through the one or more exhaust filters.

During expiration, the inlet air is reduced in flow rate due to positive user pressure created by the lungs in combination with the dynamic pressure mechanism of the compressor and all exhaust air passes through the exhaust filter media, which may be integrated into the structure of the face covering system, to remove bacterial and viral contaminants prior to exiting the mask system into the surrounding environment. All exhalation air and a small amount of fresh inlet air exhausts through the outlet filter media during expiration. The air exhaust filters are sized to ensure that all air passes through the filter media at the maximum pressure output of the blower unit. The positive pressures of the blower at all conditions is configured to ensure no outside air passes through an unfiltered interface and that all exhaust air passes through the outlet filters and not through an unfiltered interface. This creates a system that will not allow contamination of the user from the surrounding environment and will not allow the user to contaminate the surrounding environment.

In yet another aspect, the wearable personal air-filtration system may be configured for use with low, and preferably high-intensity exercise. In this configuration, the motor-driven blower flow rate may be adjustable and can achieve at or above 16 CFM during an inhalation cycle, which is 2.5 times the Maximum Voluntary Ventilation (MVV) or Maximum Breathing Capacity (MBC) of an adult male. This maximum flow rate of 16 CFM has been specifically selected to ensure that the MVV/MBC of 6 CFM is met when the user has an Expiration:Inspiration ratio of 1.5. In other words, when the user is inhaling 40% of the time and exhaling 60% of the time, 16 CFM allows a resulting maximum ventilation rate of at least 6 CFM.

In another aspect shown in FIG. 1, the wearable personal air-filtration system may be configured such that outside air is drawn in through a HEPA filter by a high efficiency, compact centrifugal blower. The HEPA filter media may remove 99.97% of the particulates prior to entry into the BLDC motor-driven blower. The pressurized, filtered air is fed into a comfortable, adjustable high sealing mask through a flexible tube and supplied to the user in flow rates that are selectable by the user. All exhaust air, primarily made up of user exhalation air, is discharged through two additional HEPA filters integrated into the mask to ensure no contaminants (bacterial, viral, etc.) are unknowingly transmitted into the surrounding environment.

In another aspect shown in FIG. 2, the wearable personal air-filtration system may be configured such that a miniature brushless DC motor drives a compact, highly efficient centrifugal blower, generating airflow and pressure which draws air through the filter and the blower and out to the mask worn by the user. The unit may be powered by a 12 V L-ion battery allowing up to, or over 3 hours of user air at the maximum flow rate and over 9 hours at the low flow setting. The airflow settings are easily adjusted by the user by rotation of the selector dial from minimum to maximum.

In another aspect shown in FIG. 3, the wearable personal air-filtration system may be configured such that airflow during inhalation (Inspiration) and exhalation (Expiration) is specifically regulated. Inlet air continuously provides positive pressure to the mask by the blower unit, preventing exhaled air from moving back through the supply tube toward the blower unit. During the inhale cycle, the personal air filtration system of the invention supplies clean, filtered air to the user and creates slight positive pressure inside the mask. During exhalation, the personal air filtration system of the invention supplies less air to the user at slightly higher pressure to ensure there is no reverse flow to the blower unit. This continuously positive airflow and pressure to the mask creates a comfortable and secure breathing environment even at the maximum breathing capacity (MBC) of an athlete during vigorous exercise.

Additional aspects of the inventive technology will become apparent from the specification, figures and claims below.

### BRIEF DESCRIPTION OF THE DRAWINGS

FIG. 1 shows a system schematic of the modular air-filtration system and apparatus of the present invention and specifically illustrates the air flow pathway for ambient air drawn through a filter and into the inlet air supply module where it is pressurized by a motorized blower unit and directed to a face covering operably coupled with the motorized blower unit in one embodiment thereof;

FIG. 2 shows a simplified cutaway view of a general embodiment of the motorized blower unit secured by the inlet air supply module in one embodiment thereof; and

FIG. 3A-B shows a schematic of the face covering operably coupled with a motorized blower unit showing the airflow paths during the: (A) inspiration cycle (inhalation), and the (B) expiration cycle (exhalation) in one embodiment thereof.

FIG. 4 shows a comparison of the personal air-filtration system of the invention to non-PAPR masks, i.e., cloth-type or surgical-type masks in terms of the effectiveness of filtering out dangerous particles (per HEPA guidelines, 99.97% filtration of particles that are 0.3 micrometers or greater). Because non-PAPR masks cannot provide a positive seal around the nose and mouth, the degree of protection from airborne particulates is decreased significantly.

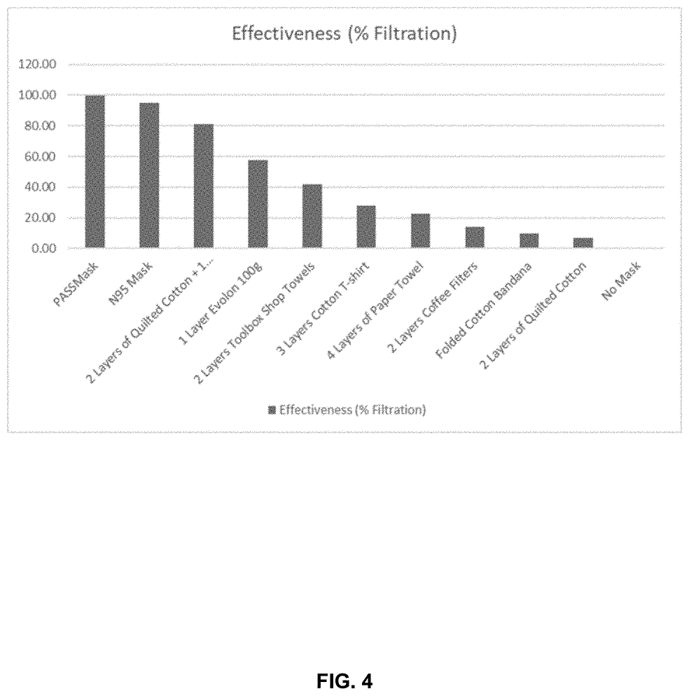

FIG. 5 shows the comparison of the personal air-filtration system of the invention to non-PAPR masks in terms of the breathability index, that is, the degree of comfort and ease in breathing while wearing the mask. It is important to note that when a person is wearing a mask during any type of activity that causes respirations to increase, or in an environment with higher temperatures, the mask can quickly become saturated with perspiration and exhalation moisture, rendering it extremely uncomfortable and difficult to breathe through. As noted above, because the personal air-filtration system of the invention provides fresh, pressurized air for inhalation, the wearer can effortlessly inhale even when respirations are increased during strenuous activity. And because of the constant supply of fresh, filtered and pressurized air, along with the non-collapsible design of the mask facepiece, the wearer's perspiration and exhaled moisture is removed with each exhalation, providing a more comfortable breathing environment.

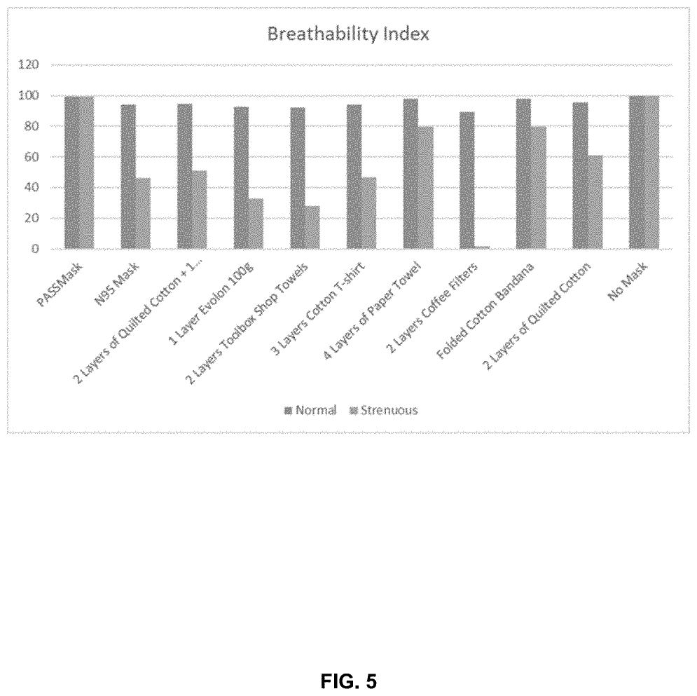

### DETAILED DESCRIPTION OF THE INVENTION

The present invention may be understood more readily by reference to the following detailed description of the preferred embodiments of the invention and the Examples included herein. It is to be understood that the terminology used herein is for the purpose of describing specific embodiments only and is not intended to be limiting. It is further to be understood that unless specifically defined herein, the terminology used herein is to be given its traditional meaning as known in the relevant art.

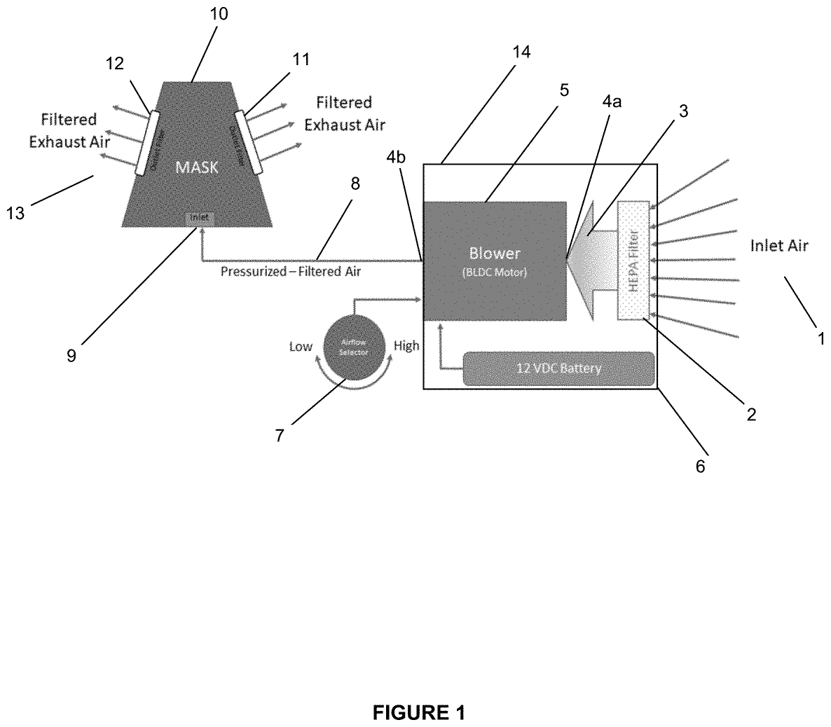

Generally referring to FIG. 1, the inventive technology provides for a personal air-filtration or purifying system having an inlet air supply module (14) securing an inlet air filter (2). As shown in FIG. 1, the inlet air filter (2) may include a filters sufficient to capture virus, bacterial, or other air-borne particulates, such as a high-efficiency particulate air (HEPA) air filter, an ultra-low particulate air (ULPA) air filter, or a N95 grade air filter and the like. As further shown in FIG. 1, a motorized blower unit (4) may have, in a preferred embodiment, a rotating compressor assembly (5) configured to adjustably draw ambient air (1) through the inlet air filter (2) generating a high velocity flow of filtered air (3) directed to the blower inlet where the action of the motorized blower unit (4) converts the directed air flow into an inversely proportional level of pressurized air within the motorized blower unit.

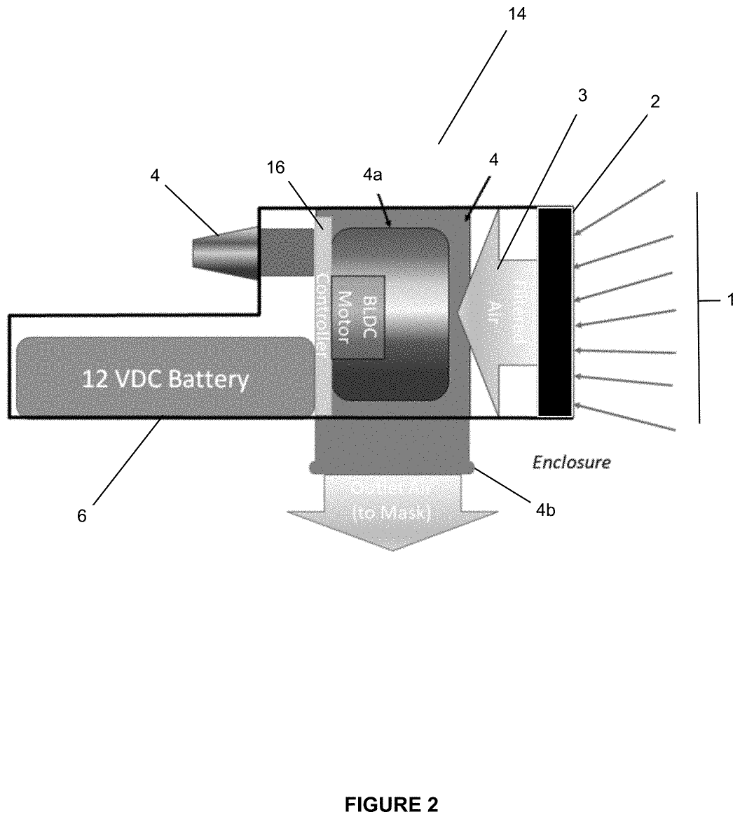

As shown in FIG. 2, the rotating compressor assembly (5) may be a brushless DC (BLDC) electric motor that is responsive to a motor controller, which as discussed below, may optionally be an air-flow selector. As further shown in FIG. 2, the motorized blower unit (4) may be powered by a power source (6), such as DC battery allowing the inlet air supply module (14) to be worn by a user, for example during exercise. As noted above, air flow from the blower may be adjustably controlled by a user through an air flow selector (7) that may increase or decrease the rotational speed of the rotating compressor assembly (5), while in alternative embodiments, the same, or a different air flow selector (7) may be configured to restrict or increase air flow from the inlet air filter (2) to the motorized blower unit (4) inlet, for example by opening or closing the channel between the inlet air filter (2) to the motorized blower unit (4) inlet.

Referring now to FIG. 1, a face covering (10) may be operably coupled with a motorized blower unit (4) such that the two components are in fluid communication with one another. In this embodiment, a connector (8), such as a flexible hose or other suitable connector (8) may be coupled with the motorized blower unit (4) outlet and a mask inlet (9) may be coupled with or integrate into the face covering (10). As shown in FIGS. 1-2, pressurized air adjustably passes through the motorized blower unit (4) outlet to a connector (8), such as a flexible connection hose, through the mask inlet (9) generating a continuous positive pressure environment inside the face covering (10).

As noted above, the face covering (10) of the invention may be configured to form a seal around a user's nose and face preventing entry of ambient air (1) into the internal environment of the face covering. However, as explained above, as an extra layer of safety, the continuous positive pressure environment generated by the air flow from motorized blower unit (4) to the internal environment of the face covering prevents entry of ambient air (1) into the internal cavity of the face covering from an unsealed or compromised portion of the seal, such as may occur due to movement by a user during exercise.

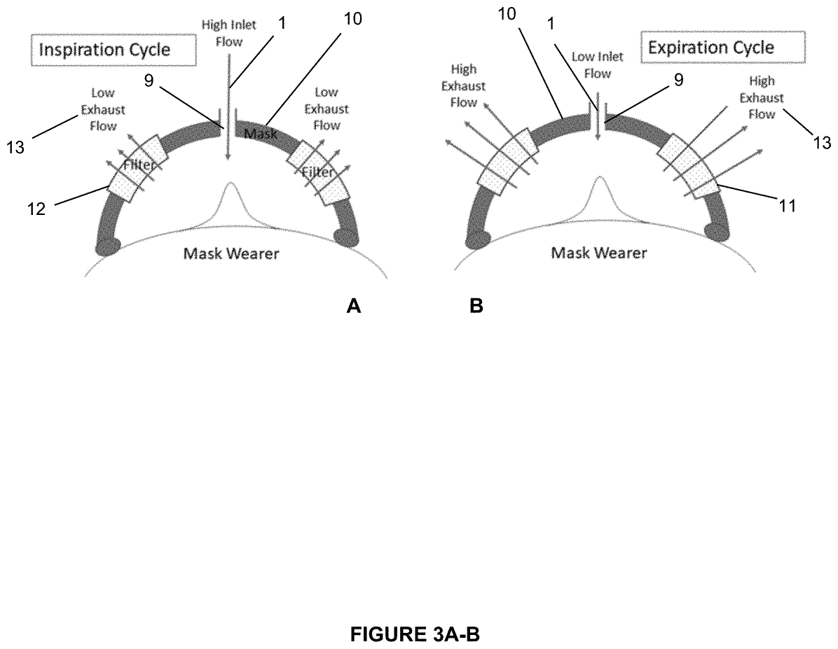

Referring now to FIGS. 1 and 3, one or more exhaust filters (11,12) may be coupled with or integrated into a face covering (10) of the invention. In this preferred embodiment, the exhaust filters (11,12) may be configured to filter expired and/or pressurized air from the face covering, generating filtered exhaust air (13), and may be further calibrated or sized such that the air that passes through the exhaust filter media matches at least the maximum pressure output of the blower unit (4). In this configuration, pressurized air within the motorized blower unit is maintained during inspiration by a user such that a check valve is not required in the outlet air flow pathway from said motorized blower unit to the user. Moreover, pressurized air within the motorized blower unit is maintained during expiration by a user such that a check valve is not required to prevent back-flow from the user to said motorized blower unit.

As noted above, the wearable air-filtration apparatus of the invention may be specifically designed to be lightweight, and easily mobile such that a user may have free range of movement while also providing sufficient volumes of air to allow the user to engage in high intensity exercise without feeling restricted or short-of-breath. As such, in one preferred embodiment, a motorized blower unit, which in this embodiment may include a rotating compressor assembly, is configured to generate air flow at least sufficient to generate: 1) a ventilation rate of at least 6 cubic feet per minute (CFM) when the user has an Expiration:Inspiration ratio of at least 1.5; or 2) 16 CFM during an inhalation cycle; or 3) 2.5 times the Maximum Voluntary Ventilation (MVV) or Maximum Breathing Capacity (MBC) of an adult male during low to high intensity exercise.

Such configured setting may be a minimum available air flow or may represent a maximum air flow setting. In alternative embodiments, the motorized blower unit (4) may be powered by a rechargeable battery such that the inlet air supply module (14) may be removed and separately charged. In this modular configuration, a user, for example at an indoor exercise or sports facility may be issued a personalized face covering (10) that may be adaptable to a plurality of interchangeable inlet air supply modules (14). In another embodiment, the connector (8) of the system may be securable to the motorized blower unit (4) outlet and the mask inlet (9) through a quick coupler or other coupling deice to allow the connector (8) to be quickly removed and/or replaced to accommodate a new user or component.

Naturally, all embodiments discussed herein are merely illustrative and should not be construed to limit the scope of the inventive technology consistent with the broader inventive principles disclosed. As may be easily understood from the foregoing, the basic concepts of the present inventive technology may be embodied in a variety of ways. It generally involves systems, methods, and techniques as well as devices to accomplish a wearable air-purification system. Such a system may employ, for example, modular components that may be configured especially for use while participating in low and high intensity exercise. In this application, the techniques, including novel and unique uses of methods and configurations, are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the inventive technology and may not explicitly show how each feature or element can actually be representative of a broader function or of a great variety of alternative or equivalent elements. Again, these are implicitly included in this disclosure. Where the inventive technology is described in device-oriented terminology, each element of the device implicitly performs a function. Apparatus claims may not only be included for the device described, but also method or process claims may be included to address the functions the inventive technology and each element performs. Neither the description nor the terminology is intended to limit the scope of the claims that will be included in any subsequent patent application.

It should also be understood that a variety of changes may be made without departing from the essence of the inventive technology. Such changes are also implicitly included in the description. They still fall within the scope of this inventive technology. A broad disclosure encompassing both the explicit embodiment(s) shown, the great variety of implicit alternative embodiments, and the broad apparatus, methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the inventive technology both independently and as an overall system.

Further, each of the various elements of the inventive technology and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the inventive technology, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this inventive technology is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of an “attachment” should be understood to encompass disclosure of the act of “attaching”—whether explicitly discussed or not—and, conversely, were there effectively disclosure of the act of “attaching”, such a disclosure should be understood to encompass disclosure of an “attachment method and/or technique, and or device” and even a “means for attaching”. Such changes and alternative terms are to be understood to be explicitly included in the description.

Any priority case(s) claimed by this application is hereby appended and hereby incorporated herein by reference in its entirety. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated herein by reference in their entirety.

Thus, the applicant(s) should be understood to have support to claim and make a statement of invention to at least: i) each of the methods, apparatus, improvements and/or devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the inventive technology, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

What is claimed is:

1. A personal air-filtration system comprising:
an inlet air supply module securing an inlet air filter and having a motorized blower unit having a rotating compressor assembly configured to adjustably draw ambient air through said inlet air filter generating high velocity filtered air flow which is converted into an inversely proportional level of pressurized air within said motorized blower unit;
a power source configured to supply power said motorized blower unit;
a face covering operably coupled with said motorized blower unit;
a mask inlet coupled with said face covering, wherein said pressurized air adjustably passes through a connector coupled with said mask inlet generating a continuous positive pressure environment inside said face covering;
one or more exhaust filters configured to filter expired and/or pressurized air from the face covering, and wherein said one or more exhaust filters are sized such that the air that passes through the exhaust filter media matches at least the maximum pressure output of the blower unit.

2. The system of claim 1, wherein said inlet air filter, and said one or more of said exhaust filters comprise high-efficiency particulate air (HEPA) air filters, ultra-low particulate air (ULPA) air filters, or N95 grade air filters.

3. The system of claim 2, wherein said motorized blower unit is responsive to an airflow selector.

4. The system of claim 1, wherein said rotating compressor assembly comprises a brushless DC (BLDC) electric motor.

5. The system of claim 4, wherein said BLDC electric motor is responsive to a motor controller.

6. The system of any of claim 1, and 4-5, wherein said rotating compressor assembly is configured to generate air flow of at least a ventilation rate of at least 6 cubic feet per minute (CFM) when the user has an Expiration:Inspiration ratio of at least 1.5.

7. The system of any of claim 1, and 4-5, wherein said rotating compressor assembly is configured to generate air flow of at least 16 CFM during an inhalation cycle.

8. The system of any of claim 1, and 4-5, wherein said rotating compressor assembly is configured to generate air flow of at least 2.5 times the Maximum Voluntary Ventilation (MVV) or Maximum Breathing Capacity (MBC) of an adult male during low to high intensity exercise.

9. The system of claim 1, wherein said power source comprises a DC battery.

10. The system of claim 1, wherein said face covering is configured to form a seal around a user's nose and face.

11. The system of claim 1, wherein said continuous positive pressure environment inside said face covering prevents entry of ambient air into the internal environment of said face covering.

12. The system of claim 1, wherein said pressurized air within said motorized blower unit is maintained during expiration by a user such that a check valve is not required to prevent back-flow from the user to said motorized blower unit.

13. The system of claim 1, wherein said pressurized air within said motorized blower unit is maintained during inspiration by a user such that a check valve is not required in the outlet air flow pathway from said motorized blower unit to the user.

14. The system of claim 1, wherein said inlet air supply module and said face covering comprise separable modular components.

15. The system of claim 1, wherein said inlet air supply module and said face covering comprise a unitary component.

16. The system of claim 1, wherein said connector is secured to said inlet air supply module with a quick coupler.

17. The system of claim 1, wherein said connector is secured to said mask inlet supply module with a quick coupler.

18. A personal air-purifying apparatus comprising:
an inlet air supply module comprising a portable housing securing an inlet air filter and a motorized blower unit configured to draw ambient air through said inlet air filter and generate pressurized air;
a power source configured to supply power said motorized blower unit
a face covering having one or more exhaust filters configured to filter expired and/or pressurized air from the face covering, operably coupled with said motorized blower unit; and
a mask inlet coupled with said face covering, wherein said pressurized air adjustably passes through a connector generating a continuous positive pressure environment inside said face covering.

19. The apparatus of claim 18, wherein said motorized blower unit comprises a rotating compressor assembly configured to adjustably draw ambient air through said inlet air filter generating high velocity filtered air flow which is converted into an inversely proportional level of pressurized air within said motorized blower unit.

20. The apparatus of claim 18, wherein said rotating compressor assembly comprises a brushless DC (BLDC) electric motor.

21. The apparatus of claim 18, wherein said BLDC electric motor is responsive to a motor controller.

22. The apparatus of claim 19, wherein said rotating compressor assembly is configured to generate air flow of at least a ventilation rate of at least 6 cubic feet per minute (CFM) when the user has an Expiration:Inspiration ratio of at least 1.5.

23. The apparatus of claim 19, wherein said rotating compressor assembly is configured to generate air flow of at least 16 CFM during an inhalation cycle.

24. The apparatus of claim 19, wherein said rotating compressor assembly is configured to generate air flow of at least 2.5 times the Maximum Voluntary Ventilation (MVV) or Maximum Breathing Capacity (MBC) of an adult male during low to high intensity exercise.

25. The apparatus of claim 18, wherein said one or more exhaust filters are sized such that the air that passes through the exhaust filter media matches at least the maximum pressure output of the blower unit.

26. The apparatus of claim 18, wherein said pressurized air within said motorized blower unit is maintained during expiration by a user such that a check valve is not required to prevent back-flow from the user to said motorized blower unit.

27. The apparatus of claim 18, wherein said pressurized air within said motorized blower unit is maintained during inspiration by a user such that a check valve is not required in the outlet air flow pathway from said motorized blower unit to the user.

28. The apparatus of claim 18, wherein said continuous positive pressure environment inside said face covering prevents entry of ambient air into the internal cavity of said face covering.

29. The apparatus of claim 18, wherein said power source comprises a DC battery

30. The apparatus of claim 18, wherein said face covering is configured to form a seal around a user's nose and face.

31. The apparatus of claim 18, wherein said inlet air filter, and said one or more of said exhaust filters comprise high-efficiency particulate air (HEPA) air filters, ultra-low particulate air (ULPA) air filters, or N95 grade air filters.

32. The apparatus of claim 18, wherein said motorized blower unit is responsive to an airflow selector.

33. The apparatus of claim 18, wherein said inlet air supply module and said face covering comprise separable modular components.

34. The apparatus of claim 18, wherein said inlet air supply module and said face covering comprise a unitary component.

35. The apparatus of claim 18, wherein said connector comprises a connector hose.

36. The apparatus of claim 35, wherein said connector hose is secured to said inlet air supply module with a quick coupler.

37. The apparatus of claim 35, wherein said connector hose is secured to said mask inlet supply module with a quick coupler.

39. A personal air-filtration exercise mask apparatus comprising:
an inlet air supply module comprising a portable housing securing an inlet air filter and a motorized blower unit configured to draw ambient air through said inlet air filter and generate pressurized air;
a face covering having one or more exhaust filters configured to filter expired and/or pressurized air from the face covering, operably coupled with said motorized blower unit; and
wherein said motorized blower unit:
generates air flow of at least a ventilation rate of at least 6 cubic feet per minute (CFM) when the user has an Expiration:Inspiration ratio of at least 1.5; or
generates air flow of at least 16 CFM during an inhalation cycle; or
air flow of at least 2.5 times the Maximum Voluntary Ventilation (MVV) or Maximum Breathing Capacity (MBC) of an adult male during low to high intensity exercise.

40. The exercise mask apparatus of claim 39, wherein said motorized blower unit comprises a rotating compressor assembly configured to adjustably draw ambient air through said inlet air filter generating high velocity filtered air flow which is converted into an inversely proportional level of pressurized air within said motorized blower unit.

41. The exercise mask apparatus of claim 40, wherein said rotating compressor assembly comprises a brushless DC (BLDC) electric motor.

42. The exercise mask apparatus of claim 40, wherein said BLDC electric motor is responsive to a motor controller.

43. The exercise mask apparatus of claim 40, wherein said rotating compressor assembly is configured to generate air flow of at least a ventilation rate of at least 6 cubic feet per minute (CFM) when the user has an Expiration:Inspiration ratio of at least 1.5.

44. The exercise mask apparatus of claim 40, wherein said rotating compressor assembly is configured to generate air flow of at least 16 CFM during an inhalation cycle.

45. The exercise mask apparatus of claim 40, wherein said rotating compressor assembly is configured to generate air flow of at least 2.5 times the Maximum Voluntary Ventilation (MVV) or Maximum Breathing Capacity (MBC) of an adult male during low to high intensity exercise.

46. The exercise mask apparatus of claim 40, wherein said one or more exhaust filters are sized such that the air that passes through the exhaust filter media matches at least the maximum pressure output of the blower unit.
